(19) United States
(12) Patent Application Publication
(10) Pub. No.: US 2001/0027422 A1
(43) Pub. Date: Oct. 4, 2001

(54) Pay for location dependant service using mobile phone payment and mobile positioning

(76) Inventor: Knut Brandrud, Oslo (NO)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/767,739

(22) Filed: Jan. 24, 2001

(30) Foreign Application Priority Data
Jan. 25, 2000 (NO) 20000382

(51) Int. Cl. G06F 17/60

(52) U.S. Cl. 705/26

(57) ABSTRACT

The present invention relates to an arrangement and a method for paying for location dependent service using a mobile phone as a payment device. The location dependent service may include a gas station, car wash or a train or subway station. The user of the mobile device initiates a request/order of the service or goods. The service provider offering the service or goods will determine the geographical position of the cellular device. Based on the approximate geographical position determined, the service location will provide the service or goods.

### TECHNICAL FIELD

The invention is applicable in Wireless Electronic Commerce. The invention is applicable in wireless networks like GSM, TDMA and CDMA.

### TECHNICAL BACKGROUND

### The Problem Area

The problem is to enable payment for a location dependant service using the mobile phone as a payment device. The service is provided in several locations, and the location of the specific service required is necessary in order to initiate the transaction. This means that the service or good to be purchased is linked to a specific service location. The physical distribution of the service locations is such that mobile positioning services securely can detect each service location. The target is solutions that may be implemented mainly in software, i.e. does not need a shorthold physical connection (like Bluetooth radio based connection or infrared) between the user and the location dependant service. Examples of such services are:

Pay at gas station. The customer wants to use his/her mobile phone as a payment device. The customer selects a gas station payment service on his/her mobile phone, e.g. provided by a gas station company.

Pay for car wash. This enables the customer to pay for the service and perform the car wash without the need to get out of the car.

Pay for ticket at a train or subway station. The user wants to buy a ticket at an un-manned station equipped with a ticketing machine. The ticketing service detects the station, asks the user for acceptance of station and optionally ticket machine identity (if more than one ticket machine at the same location), and prints the purchased ticket at the ticketing machine.

The common denominator is the need for connecting your mobile phone, which includes payment capabilities, to a physical service without the need for selecting the location manually prior to the purchase. It should also be possible to include such a new payment service by software only at the service location.

### Known Solutions

Known solutions are:

1. Using a short-hold communication mechanism like Bluetooth, infrared or other contact-less communication media for establishment of a relation between the user's device and the service location.

2. Establishing a relation to the service location by other means, i.e. type in an identity of the service location during a user dialogue, or typing the identity of the user (e.g. the mobile phone number) from a panel at the service location.

### Problems with Known Solutions

1. Some mobile phones has integrated infrared communication today, but a means for an application on the phone to control this communication is not standardised, and hence this is not feasible in the short term. In the longer term, it is foreseen that Bluetooth transceivers will be included in most phones, also including means for a phone application to access the short-hold communication channel. Hence, this may be the longer-term solution for the problem, but requires new hardware on handset and at the service location.

2. The manual selection of service location via user dialogue is manageable, but the possible success of such services will depend on a very simple and intuitive user dialogue with the service location. The simpler the user dialogue is, the better is the chance for success.

### The Invention

### SUMMARY OF THE INVENTION

An object of the present invention is to provide a means to purchase a good/service that can be offered at several places, via the same user dialogue with the service provider, and without needing to indicate the actual service location where the service is offered. The main advantage with this is simplifying the user dialogue. Furthermore, the user dialogue may be initiated before the user is in physical reach of the service location. E.g. when approaching the railway station (within a certain radius of the service location) the transaction may be initiated to reduce transaction delay waiting for the ticket to be printed.

This object is achieved in an arrangement and method according to the present invention as defined in the appended patent claims.

### BRIEF DESCRIPTION OF THE DRAWINGS

The invention will now be described in relation to the appended drawings, of which:

FIG. 1 shows the entities involved in a transaction using the invention,

FIG. 2 shows a network architecture example for systems using the solution.

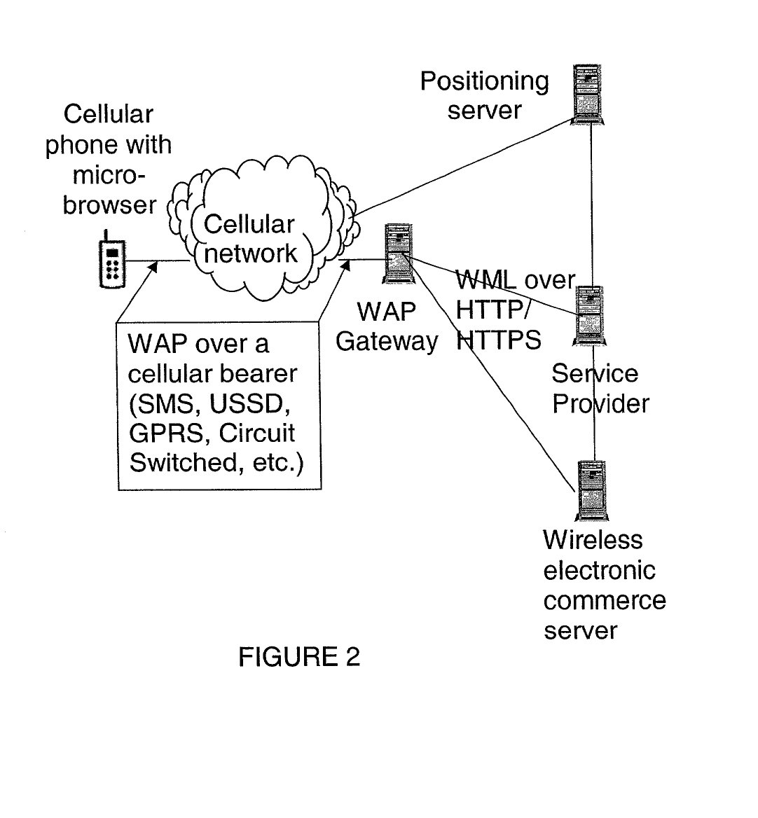

### DETAILED DESCRIPTION

The invention combines a cellular device based payment solution with a positioning service. The system consists of a number of functional entities. Some of the entities may be realised in the same network element.

1. A user with a cellular device.

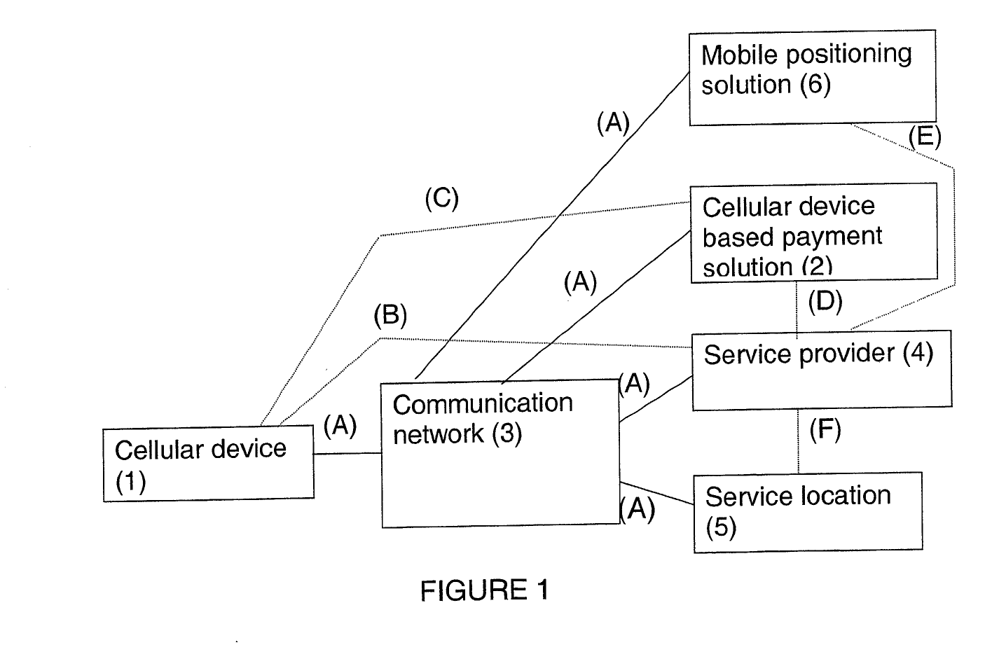

The user wants to buy a service/good at a certain location, using his/her cellular device to pay for the service/good (The reference numerals refer to FIG. 1).

2. A cellular device based payment solution.

A number of solutions for payment via the mobile phone are being developed. In the context of this invention, the cellular device based payment solution provides the ability for the mobile user to initiate and fulfil a payment transaction from his/her mobile phone, and in this way being able to pay for the targeted service provided at the service location. The payment may be performed in several ways, depending of the actual capabilities of the cellular device based payment solution. Examples are card based payment (with or without using the physical card in the transaction) or various types of account or token based payments. The invention does not put any specific requirements on the actual payment method, as long as it enables a payment transaction from the user to the service provider using the cellular device.

3. A communication Network.

The communication network provides the communication between the cellular device and the network-based services, i.e. the cellular device based payment solution and the service provider that provides the service/good to be paid for. This entity will at least consist of a cellular network, but may also consist of other networks (e.g. IP based networks) between the cellular device and the network based services.

4. A service provider that provides the service/good to be paid for.

The service provider is the entity that formally offers the service/good. It may be a gas station company, train company, etc. The payment transaction will start between the cellular device and the service provider by a user initiated action on the cellular device. At this stage the service provider does not know the actual location of the service/good to be paid for. The invention provides the ability for the service provider to link the user represented by the cellular device to the actual service location.

5. A Service Location.

This is the actual instance of the service provider's service/good, i.e. a physical entity that provides the service/good, or provides something that represents the service/good (e.g. a ticket).

6. A mobile positioning solution.

This solution enables the service provider to determine where the cellular device initiating the transaction is located, and based on this, determine which Service Location that shall offer the good or service. The position may be retrieved using positioning services provided in the cellular network, or other solutions like GPS built into the cellular device. A cellular based positioning system may be network based (retrieving and processing information from the base stations) or client based (using client intelligence that has access to positioning information in the cellular device).

The interfaces involved are:

(A) Network interfaces. The invention is independent of the actual communication media and protocol being used.

(B) A logical connection between the cellular device and the service provider that provides the service/good to be paid for. The connection may be based on any protocol enabling a user dialogue initiated by the user of the cellular device. Examples of possible protocols are Wireless Application Protocol and various SMS based protocols.

(C) A logical connection between the cellular device and the cellular device based payment solution. The connection can be based on any protocol enabling a user dialogue initiated by the user of the cellular device. Examples of possible protocols are Wireless Application Protocol and various SMS based protocols.

(D) A logical connection between the two entities. This can be based on any type of open or proprietary interface between the two entities. The two entities may also be a common entity in case the service provider also provides the payment solution. This interface provides the interaction between the service provider that provides the service/good to be paid for, and the cellular device based payment solution.

(E) A logical connection between the two entities. This can be based on any type of open or proprietary interface between the two entities. This interface provides the interaction between the service provider that provides the service/good to be paid for, and the mobile positioning solution. Parts of or all of the positioning functionality may also be located in the cellular device.

(F) A logical connection between the two entities. This can be based on any type of open or proprietary interface between the two entities. This interface provides the interaction between the service provider that provides the service/good to be paid for, and the service location where the service/good is provided to the user.

The transaction using the invention will be:

1. The user of the cellular device initiates a request/order of the actual service/good, using his/her cellular device. The request does only need to indicate the service provider, not the service location actually providing the service/good. This involves entity (1), (3) and (4).

2. The service provider offering the service/good will determine the actual geographical position of the user of the cellular device. This will be done using the mobile positioning solution. Based on the approximate geographical position determined, the actual service location that will provide the service/good (e.g. gas station, ticket machine) is determined. This involves entity (4) and (6).

3. The service location providing the service/good will be connected to the service provider, and the service provider determines if the service/good actually can be provided to the user of the cellular device. This involves entity (4) and (5).

4. The payment for the service/good is handled according to the payment mechanism implemented. This involves entity (2) and (4).

5. The service/good is delivered to the user of the cellular device. This involves entity (1) and (5).

### Broadening

The invention may be used for any service that has the necessary geographical distribution so that a mobile positioning system provides the necessary accuracy.

The invention may be combined with a service requesting the nearest service location for a specific service/good. An example is a service providing information of the nearest gas station of a specific brand. After providing the information, a transaction is initiated. As soon as the user enters a given radius of the service location, a purchase offer is pushed to the wireless device.

### Definitions and Abbreviations

GSM

Global System for Mobile Communications. A digital cellular phone technology based on TDMA that is widely deployed in Europe and throughout the world.

Cellular Device

A device that can communicate over a cellular network like GSM, AMPS and TDMA, e.g. a mobile phone or another mobile device with communication capabilities.

Service Provider

Someone providing services or goods to a user. In this invention the service provider will be the one that provides the service or good to be paid for using the cellular device.

Service location

The physical representation of the service to be paid for. This will be the entity that gives the user the service/good (e.g. a gas station pump) or a ticket/receipt representing the service/good (e.g. a train ticket).

Gateway

A network point that acts as an entrance to another network. In a company network, a proxy server acts as a gateway between the internal network and the Internet. A gateway may also be any device that passes packets from one network to another network in their trip across the Internet.

Microbrowser

A slimmer variant of a WWW browser tailored for thin clients with small displays and low bandwidth communication. Examples of a microbrowser is the browser on a WAP client, e.g. a WAP enabled phone.

WAP

Wireless Application Protocol. A wireless standard initially proposed by Motorola, Ericsson and Nokia for providing small wireless devices like phones and PDAs access to Internet type content. WAP uses the Wireless Markup Language (WML) for presenting Internet content.

1. Arrangement for buying a service/goods at a service location, using a cellular device to pay for the service/goods, characterized in a service location which is the actual instance of a service provider's service/goods, i.e. physical entity that provides the service/goods,
a mobile positioning solution which enables the service provider to determine where the cellular device initiating the transaction is located, and based on this, determine which service location that shall offer the goods or service
a communication network which provides the communication between the cellular device and the network-based services.

2. Arrangement as claimed in claim 1, characterized in that the mobile positioning solution is based on position services provided in the cellular network.

3. Arrangement as claimed in claim 2, characterized in that said cellular based positioning solution is network based, by retrieving and processing information from base stations.

4. Arrangement as claimed in claim 2, characterized in that said cellular based positioning solution is client based by using client intelligence that has access to positioning information in the cellular device.

5. Arrangement as claimed in claim 1, characterized in that the mobile positioning solution is based on a GPS receiver built into the cellular device.

6. Method for buying service/goods at a service location, using a cellular device to pay for the service/goods, characterized in that the method includes the following steps:
A user of the cellular device initiates a request/order of the actual service/goods, using his/her cellular device
A service provider offering the service/goods determine the actual geographical position of the cellular device
Based on the approximate geographical position determined, the actual service location that will provide the service/goods is/are determined
The payment for the service/goods are handled according to the payment mechanism involved
The service/goods is/are delivered to the user of the cellular device.
